(19) United States
(12) Patent Application Publication
(10) Pub. No.: US 2007/0298225 A1
(43) Pub. Date: Dec. 27, 2007

(54) CIRCUIT SUBSTRATE WITH STRONG ADHESION

(75) Inventors: Chi-Jang Lo, Taipei City (TW); Li-Chih Fang, Hsinchu (TW)

Correspondence Address: INTELLECTUAL PROPERTY LAW GROUP LLP, 12 SOUTH FIRST STREET, SUITE 1205, SAN JOSE, CA, 95113, US

(73) Assignee: POWERTECH TECHNOLOGY INC., Hsinchu (TW)

(21) Appl. No.: 11/535,946

(22) Filed: Sep. 27, 2006

(30) Foreign Application Priority Data
Jun. 22, 2006 (TW) 95210938

(51) Int. Cl. B32B 9/04

(52) U.S. Cl. 428/195.1; 428/411.1; 428/343

(57) ABSTRACT

The surface of the circuit substrate is a solder mask. The solder mask protects the electrical circuit on the circuit substrate against suffering from the environmental damage. By dividing the area of the circuit substrate into the solder mask area and the adhesive area, a bismaleimide triazine layer is formed on the surface of the circuit substrate to coarsen the adhesive area and so as to enhance the adhesion strength between the chip and the circuit substrate.

### CROSS-REFERENCE TO RELATED APPLICATIONS

This application claims foreign priority under 35 U.S.C. §119 to Taiwanese Patent Application no. 95210938, filed in Taiwan, Republic of China on Jun. 22, 2006, the entire contents of which are hereby incorporated by reference.

### BACKGROUND OF THE INVENTION

1. Field of the Invention

This invention relates to a substrate, especially, to a substrate with strong adhesion.

2. Background of the Related Art

Chip fixed on a substrate connects electrically to the circuit on the substrate and to an external circuit, and the stability of the adhesive will upgrade or downgrade the quality of the electrical conductance.

FIG. 1 is a top-view schematic diagram of a known layout for adhering a chip onto a substrate with circuits. A solder mask area 100 includes multiple adhesive areas 110, and the solder mask covers the solder mask area 100 including all of the adhesive areas 110.

The solder mask disposed on a substrate can protect the circuits on the substrate, but the solder mask has a slippery surface. Thus, it is not easy to adhere a chip on the substrate. The quality of the conductance between the chip and the circuits on the substrate will downgrade when the chip moves on the slippery surface of the substrate.

Therefore, there is a need to process the surface of the adhesive areas 110 to enhance the adhesion strength between the chip and the substrate.

### SUMMARY OF THE INVENTION

An object of this invention is to enhance the adhesion strength of the adhesive areas between the chip and the substrate as mentioned above.

For achieving the aforementioned object, one embodiment according to this invention provides a structure of a substrate including at least a coarsened area to paste a chip, and a solder mask area surrounding the coarsened area to protect the circuit on the substrate. The area of the coarsened area is similar to or smaller than the area that the chip is pasted onto.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a top-view schematic diagram of a known layout for adhering a chip onto the circuit substrate.

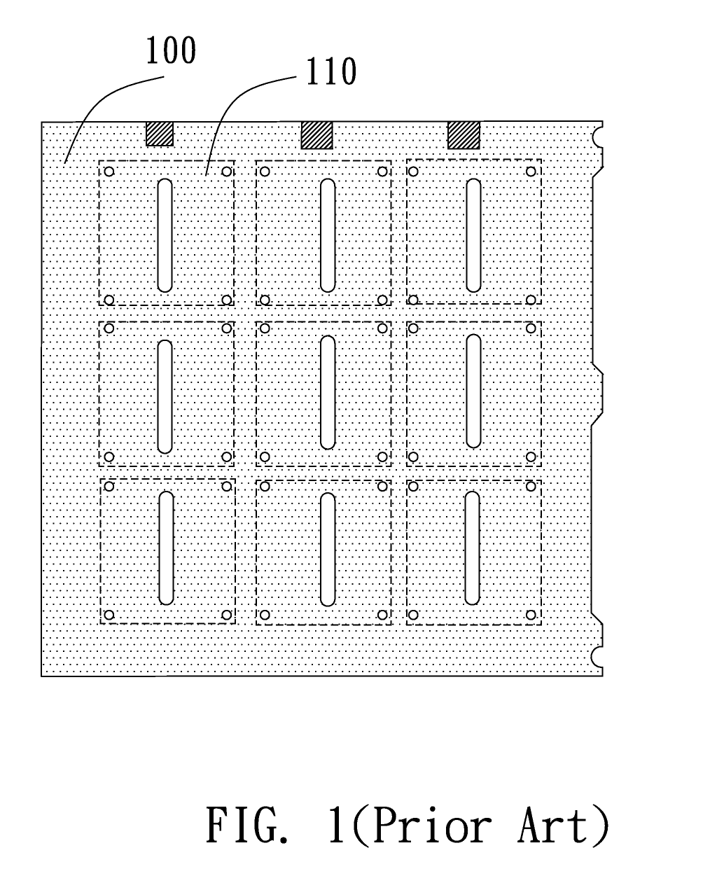

FIG. 2 is a top-view schematic diagram of a layout of a coarsened area including multiple adhesive areas on the circuit substrate according to one embodiment of this invention.

FIG. 3 is a top-view schematic diagram of a layout including multiple coarsened areas on the substrate according to one embodiment of this invention.

FIG. 4 is a top-view schematic diagram of a layout including various drawings for different relations between the coarsened area and the adhesive areas on the substrate according to one embodiment of this invention.

### DETAILED DESCRIPTION OF THE INVENTION

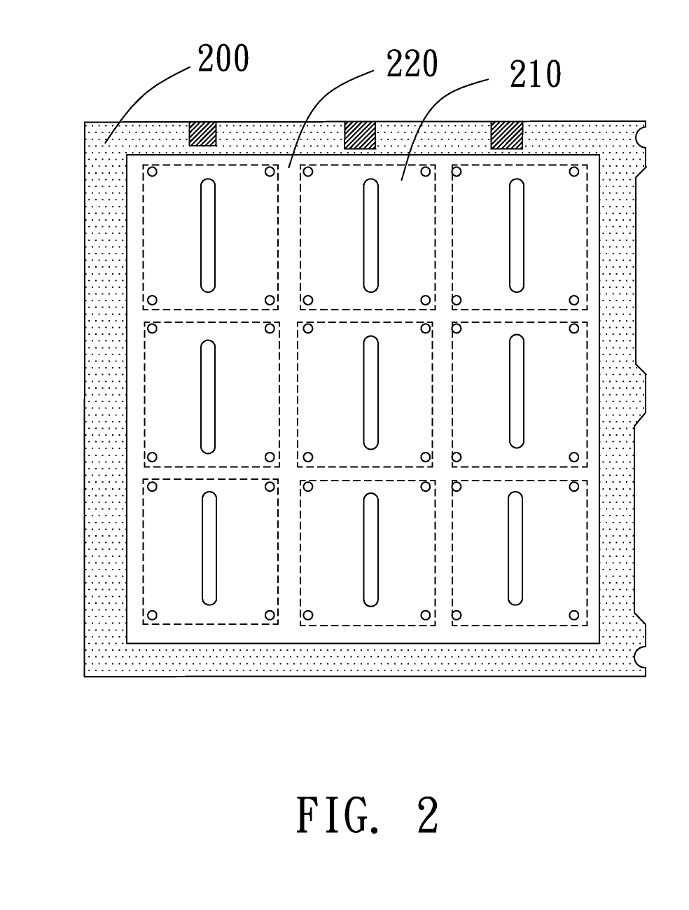

FIG. 2 is a top-view schematic diagram of a substrate layout according to one embodiment of this invention. The substrate includes a solder mask area 200 and a large coarsened area 220 having multiple adhesive areas 210. The adhesive areas 210 are coarsened at the same time when the large coarsened area 220 is coarsened, and the coarsening method is to form a bismaleimide triazine layer on the substrate.

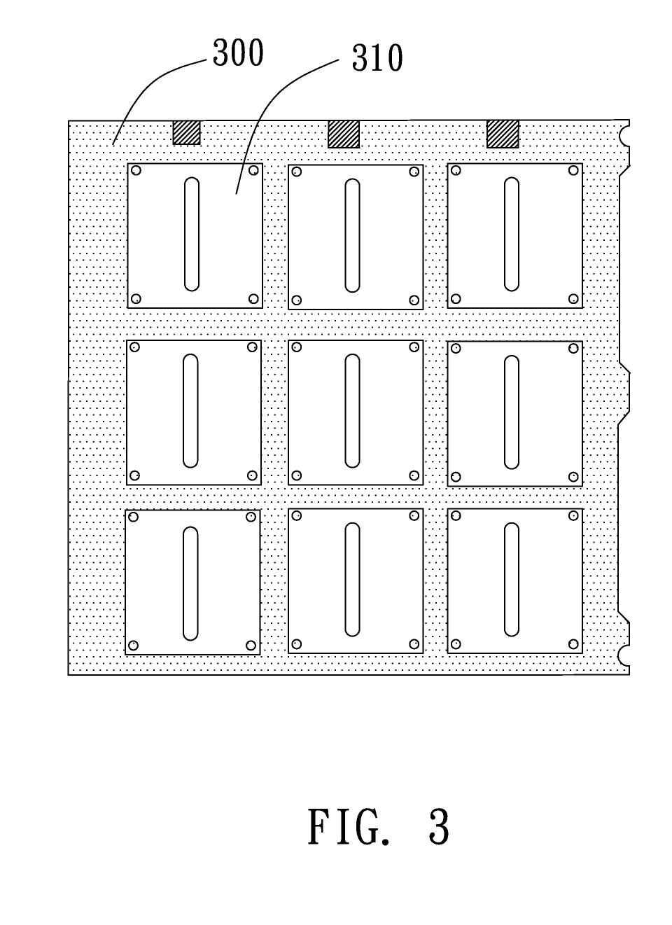

FIG. 3 is a top-view schematic diagram of a substrate layout according to one embodiment of this invention. The substrate includes a solder mask area 300 and multiple coarsened areas, and each coarsened area includes multiple adhesive areas 310. For being better understood, the coarsened areas coincide with the adhesive areas 310 in the present embodiment. The coarsening method, similar to the aforementioned, is to form a bismaleimide triazine layer over the adhesive area 310 on the substrate.

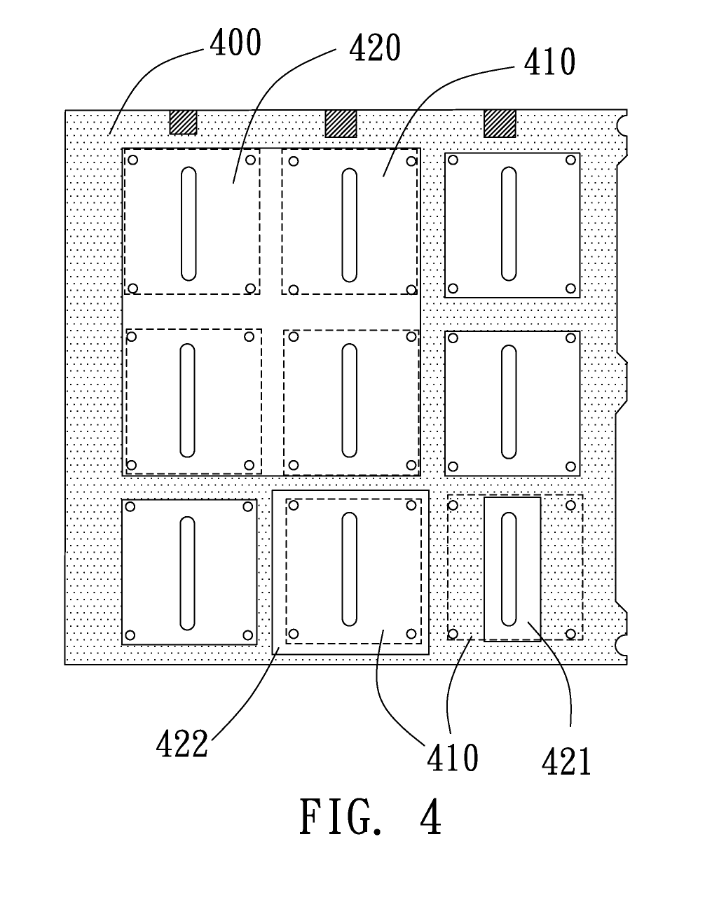

The object of the coarsened area is to enhance the adhesion strength for pasting a chip onto the substrate. The area of the coarsened area may be smaller than the area of the adhesive area. Besides, a substrate may include multiple coarsened areas and each coarsened area includes multiple adhesive areas. Therefore, the chips must be pasted on the adhesive area with coarsened surface. For example, the embodiment shown in FIG. 4, a coarsened area 420 includes multiple adhesive areas 410, a coarsened area 421 is smaller than an adhesive area 410, and a coarsened area 422 is bigger than an adhesive area 410.

Although the present invention has been explained in relation to its preferred embodiment, it is to be understood that other modifications and variation can be made without departing the spirit and scope of the invention as claimed.

What is claimed is:

1. A substrate, comprising:
a solder mask area; and
at least one coarsened area with a coarsened surface, surrounded by said solder mask area, wherein said coarsened area comprises at least one adhesive area.

2. A substrate according to claim 1, wherein a bismaleimide triazine material makes said coarsened surface.

3. A substrate according to claim 1, wherein the areas of any two of said coarsened areas are the same.

4. A substrate according to claim 1, wherein the areas of any two of said coarsened areas are different.

5. A substrate according to claim 1, wherein the area of said adhesive area is the same as the area of said coarsened area.

6. A substrate according to claim 1, wherein the area of said adhesive area is different from the area of said coarsened area.
